(19) United States
(12) Patent Application Publication
(10) Pub. No.: US 2023/0392815 A1
(43) Pub. Date: Dec. 7, 2023

(54) VOLUMETRIC-FLOW CONTROLLER HAVING AN INTEGRATED AIR QUALITY SENSOR

(71) Applicant: Gruner AG, Wehingen (DE)

(72) Inventors: Wolfgang Spreitzer, Wehingen (DE); Kevin Dillinger, Spaichingen (DE); Wolfgang Moser, Obernheim (DE)

(73) Assignee: Gruner AG, Wehingen (DE)

(21) Appl. No.: 18/452,459

(22) Filed: Aug. 18, 2023

Related U.S. Application Data
(63) Continuation of application No. PCT/EP2022/054354, filed on Feb. 22, 2022.

(30) Foreign Application Priority Data
May 3, 2021 (EP) 21 171 779.8

(51) Int. Cl. F24F 11/74; F24F 11/89

(52) U.S. Cl. CPC F24F 11/74; F24F 11/89; F24F 2110/40

(57) ABSTRACT

A volumetric-flow controller for adjusting a control flap is movably mounted within a flow channel. A measurement channel has a channel inlet and outlet for connection to the flow channel forming a separate bypass channel branched from the flow channel. A differential pressure sensor arranged in the measurement channel measures a differential pressure prevailing in the flow channel and outputs a corresponding electrical measurement signal. A control unit for electrically activating a flap drive in dependence on the electrical measurement signal outputted by the differential pressure sensor sets a desired volumetric flow rate in the flow channel. At least one air quality sensor arranged in the measurement channel measures an air quality prevailing in the flow channel and outputs a corresponding electrical measurement signal. The control unit electrically activates the flap drive in dependence on the electrical measurement signal outputted by the at least one air quality sensor.

### CROSS-REFERENCE TO RELATED APPLICATIONS

This continuation application claims priority to PCT/EP2022/054354 filed on Feb. 22, 2022 which has published as WO 2022/233472 A1 and also the European application number 21 171 779.8 filed on May 3, 2021, the entire contents of which are fully incorporated herein with these references.

### DESCRIPTION

### Field of the Invention

The present invention relates to a volumetric-flow controller, in particular for air-conditioning and ventilation systems, for adjusting a control flap which is movably mounted within a flow channel, comprising a measurement channel which has a channel inlet and a channel outlet for connection to the flow channel in order to form a separate bypass channel branched from the flow channel, a differential pressure sensor arranged in the measurement channel for measuring a differential pressure prevailing in the flow channel and for outputting a corresponding electrical measurement signal, and a control unit for electrically activating a flap drive in dependence on the electrical measurement signal outputted by the differential pressure sensor in order to set a desired volumetric flow rate in the flow channel.

### Background of the Invention

Such a volumetric-flow controller has become known, for example, from EP 1 950 508 A2.

Such volumetric-flow controllers serve to set a volumetric flow rate through a flow channel in air-conditioning and ventilation systems. By way of a differential pressure sensor, a differential pressure is determined in the flow channel and an actual value is calculated therefrom. This actual value is compared in a control device with a stored desired value. In the event of a deviation, the control device adjusts a control flap provided in the flow channel in order thus to correspondingly set the volumetric flow rate between a minimum and a maximum permissible volumetric flow rate.

### SUMMARY OF THE INVENTION

In light of the above, the object of the present invention is to broaden the field of use of a volumetric-flow controller of the type mentioned at the beginning.

This object is achieved according to the invention in that at least one air quality sensor for measuring an air quality prevailing in the flow channel and for outputting a corresponding electrical measurement signal is arranged in the measurement channel, and the control unit is configured to electrically activate the flap drive in dependence on the electrical measurement signal outputted by the at least one air quality sensor.

According to the invention, in addition to the differential pressure sensor, also an air quality sensor, such as, for example, a CO₂ sensor or VOC (volatile organic compounds) sensor is arranged in the volumetric-flow controller. Thus, for example in the case where the CO₂ concentration detected in the flow channel is too high, the flap drive can be electrically activated by the control unit in order to close the flow channel by means of the control flap. A single air quality sensor or a plurality of different air quality sensors can be arranged in the measurement channel.

The at least one air quality sensor is arranged in the measurement channel preferably in series with the differential pressure sensor, either between the channel inlet and the differential pressure sensor or between the differential pressure sensor and the channel outlet.

Preferably, the at least one air quality sensor has a sensor surface which is arranged in the measurement channel parallel or approximately parallel to the direction of flow of the air flowing past the sensor surface. The air flowing through the measurement channel thus does not impinge on the sensor surface but flows along the sensor surface, so that the measurement results are not falsified by impinging air.

Particularly preferably, the measurement channel has on a straight measurement channel portion a wall recess in which the at least one air quality sensor is arranged and sealed by means of a seal.

The invention relates also to an assembly comprising a flow channel, a control flap which is movably mounted within the flow channel, a volumetric-flow controller as described above which is connected by its channel inlet and its channel outlet to the flow channel in order to form a separate bypass channel branched from the flow channel, and a flap drive, which is electrically activated by the control unit, for moving the control flap in dependence on the electrical measurement signals outputted by the differential pressure sensor and by the at least one air quality sensor.

Further advantages of the invention will become apparent from the description and the drawing. Likewise, the features mentioned above and those listed hereinbelow can be used each on its own or a plurality of such features can be used in any desired combinations. The embodiment shown and described is not to be understood as being exhaustive but instead is of an exemplary nature for describing the invention.

### BRIEF DESCRIPTION OF THE DRAWINGS

In the drawing:

FIG. 1 shows a perspective view of a volumetric-flow controller according to the invention;

FIG. 2 shows, schematically, the interior of the volumetric-flow controller of FIG. 1 connected to a flow channel;

FIG. 3 shows a sensor system of the volumetric-flow controller;

FIG. 4 shows an air quality sensor of the sensor system shown in FIG. 3; and

FIG. 5 shows a longitudinal section through the sensor system shown in FIG. 4.

### DETAILED DESCRIPTION OF EMBODIMENTS OF THE INVENTION

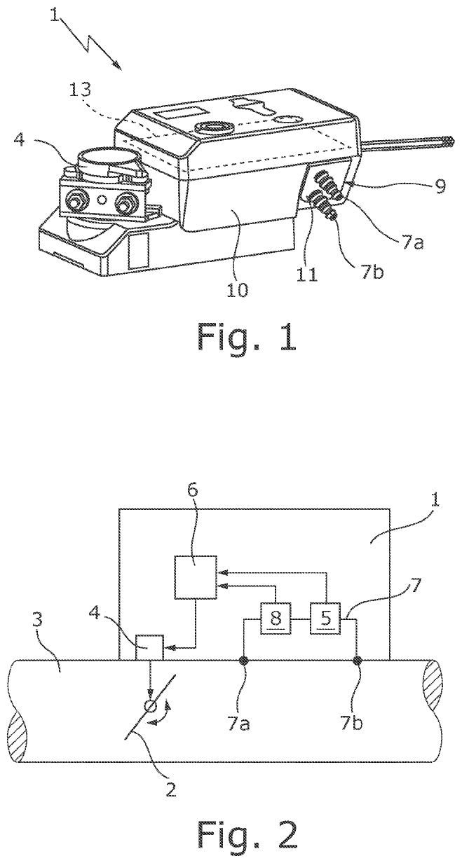

The volumetric-flow controller 1 shown in FIGS. 1 and 2 serves to adjust a volumetric flow rate in air-conditioning and ventilation systems by means of a control flap 2 which is pivotably mounted within a flow channel 3.

To that end, the volumetric-flow controller 1 comprises a flap drive (e.g. a motor with a reduction gear) 4 for pivoting the control flap 2, a differential pressure sensor 5 for measuring a differential pressure prevailing in the flow channel 3, and a control unit 6 which electrically activates the flap drive 4 in dependence on the pressure measured by the differential pressure sensor 5, that is to say in dependence on the electrical differential pressure measurement signal outputted by the differential pressure sensor 5, in order to set a desired volumetric flow rate in the flow channel 3. As is shown, the volumetric-flow controller 1 can advantageously also comprise the flap drive 4.

The differential pressure sensor 5 is arranged in a measurement channel 7 which here is U-shaped by way of example and which is connected to the flow channel 3 at one end by a channel inlet 7a and at the other end by a channel outlet 7b and thus forms a separate bypass channel branched from the flow channel 3. Further, an air quality sensor 8 for measuring an air quality prevailing in the flow channel 3 is arranged in the measurement channel 7. Preferably, the air quality sensor 8 is a CO₂ sensor or a VOC sensor. In dependence on the air quality measured by the air quality sensor 8, that is to say in dependence on the electrical measurement signal outputted by the air quality sensor 8, the control unit 6 electrically activates the flap drive 4 in order to correspondingly free or close the flow channel 3. As is shown, the air quality sensor 8 is preferably arranged in series with the differential pressure sensor 5, here by way of example between the channel inlet 7a and the differential pressure sensor 5. Alternatively, the air quality sensor 8 can also be arranged in the measurement channel 7 between the differential pressure sensor 5 and the channel outlet 7b.

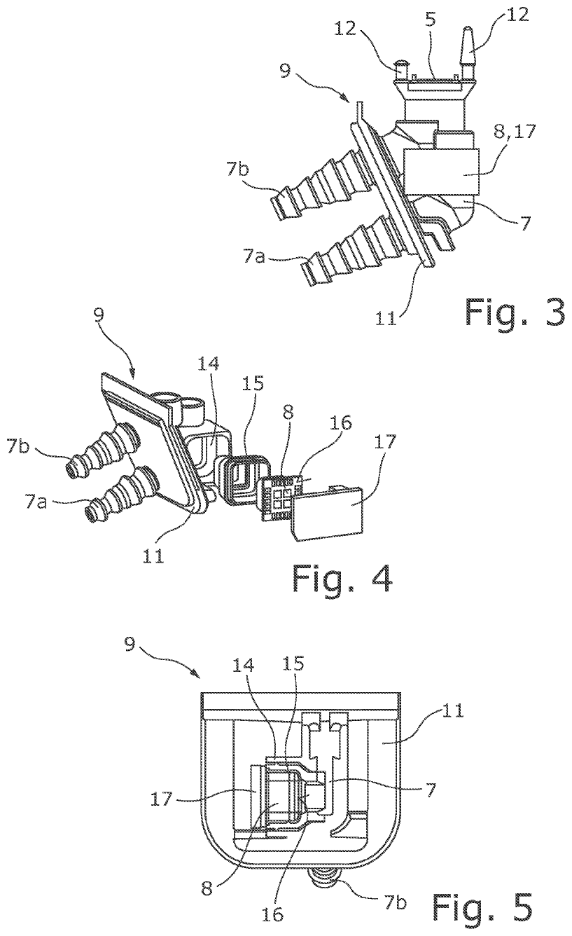

As is shown in FIG. 3, the measurement channel 7, together with the channel inlet 7a and the channel outlet 7b, is in the form of a separate cover part 9 (e.g., of plastics material), which is fastened in an opening of a controller housing 10 (FIG. 1). The cover part 9 has a cover plate 11 which closes the opening of the controller housing 10. The channel inlet 7a and the channel outlet 7b are located in the form of connection pieces on the outside of the cover part 9, while the measurement channel 7, together with the differential pressure and air quality sensors 5, 8, is located on the inside of the cover part 9. The cover part 9 has a plurality of latching pins 12 with which the cover part 9 is fastened to a circuit board 13 (FIG. 1) of the control unit 6, namely while at the same time electrically connecting the differential pressure sensor 5 to the circuit board 13.

As is shown in FIG. 4, the measurement channel 7 has on a straight measurement channel portion a wall recess 14 in which the air quality sensor 8 is arranged and which is sealed by means of a seal 15. A sensor surface 16 of the air quality sensor 8 runs in the measurement channel 7 parallel or approximately parallel to the direction of flow of the air flowing past the sensor surface 16, so that the air flowing through the measurement channel 7 does not impinge on the sensor surface 16 but flows, preferably in parallel, along it. The air quality sensor 8 is electrically fastened to an additional circuit board 17, which in turn is electrically connected to the circuit board 13, for example by means of a short cable.

In FIG. 5, the sealed arrangement of the air quality sensor 8 in the wall recess 14 of the measurement channel 7 is again shown in a longitudinal section.

As an alternative, instead of the air quality sensor shown, a plurality of different air quality sensors, for example a CO₂ sensor and a VOC sensor, can also be arranged in the measurement channel 7 and connected to the control unit 6.

What is claimed is:

1. A volumetric-flow controller configured for air-conditioning and ventilation systems, for adjusting a control flap which is movably mounted within a flow channel, the volumetric-flow controller comprising:
a measurement channel having a channel inlet and a channel outlet for connection to the flow channel in order to form a separate bypass channel branched from the flow channel;
a differential pressure sensor arranged in the measurement channel for measuring a differential pressure prevailing in the flow channel and for outputting a corresponding electrical measurement signal; and
a control unit for electrically activating a flap drive in dependence on the electrical measurement signal outputted by the differential pressure sensor in order to set a desired volumetric flow rate in the flow channel;
wherein at least one air quality sensor for measuring an air quality prevailing in the flow channel and for outputting a corresponding electrical measurement signal is arranged in the measurement channel, and the control unit is configured to electrically activate the flap drive also in dependence on the electrical measurement signal outputted by the at least one air quality sensor.

2. The volumetric-flow controller as claimed in claim 1, wherein the at least one air quality sensor is arranged in the measurement channel in series with the differential pressure sensor.

3. The volumetric-flow controller as claimed in claim 2, wherein the at least one air quality sensor is arranged in the measurement channel between the channel inlet and the differential pressure sensor or between the differential pressure sensor and the channel outlet.

4. The volumetric-flow controller as claimed in claim 1, wherein the at least one air quality sensor has a sensor surface which is arranged in the measurement channel parallel or approximately parallel to the direction of flow of the air flowing past the sensor surface.

5. The volumetric-flow controller as claimed in claim 1, wherein the measurement channel has on a straight measurement channel portion a wall recess in which the at least one air quality sensor is arranged.

6. The volumetric-flow controller as claimed in claim 5, wherein the at least one air quality sensor is sealed in the wall recess by means of a seal.

7. The volumetric-flow controller as claimed in claim 1, wherein the at least one air quality sensor is a CO₂ sensor or a VOC sensor.

8. The volumetric-flow controller as claimed in claim 1, wherein a plurality of different air quality sensors are arranged in the measurement channel.

9. The volumetric-flow controller as claimed in claim 1, wherein the at least one air quality sensor is electrically connected to the control unit.

10. The volumetric-flow controller as claimed in claim 1, wherein the at least one air quality sensor is electrically connected to the control unit by means of a cable.

11. The volumetric-flow controller as claimed in claim 9, wherein the differential pressure sensor is fastened to a circuit board of the control unit and is electrically connected thereto, and the at least one air quality sensor is electrically connected to the circuit board.

12. The volumetric-flow controller as claimed in claim 1, wherein the measurement channel is carried on a cover part which has on an outer side the channel inlet and the channel outlet and on an inner side the differential pressure sensor and the air quality sensor.

13. The volumetric-flow controller as claimed in claim 1, wherein the measurement channel is carried on a cover part, being a plate-shaped cover part, which has on an outer side the channel inlet and the channel outlet and on an inner side the differential pressure sensor and the air quality sensor.

14. The volumetric-flow controller as claimed in claim 1, wherein the volumetric-flow controller also comprises the flap drive.

15. An assembly comprising the flow channel, the control flap which is movably mounted within the flow channel and the volumetric-flow controller as claimed in claim 1 which is connected to the flow channel by its channel inlet and its channel outlet in order to form a separate bypass channel branched from the flow channel, and the flap drive which is electrically activated by the control unit for moving the control flap in dependence on the electrical measurement signals outputted by the differential pressure sensor and by the at least one air quality sensor.
